(19) United States
(12) Patent Application Publication
(10) Pub. No.: US 2013/0044951 A1
(43) Pub. Date: Feb. 21, 2013

(54) MOVING OBJECT DETECTION METHOD USING IMAGE CONTRAST ENHANCEMENT

(71) Applicants: Der-Chun CHERNG, New Taipei City (TW); Yan-Chen LU, New Taipei City (TW)

(72) Inventors: Der-Chun CHERNG, New Taipei City (TW); Yan-Chen LU, New Taipei City (TW)

(21) Appl. No.: 13/280,084

(22) Filed: Oct. 24, 2011

(30) Foreign Application Priority Data
Aug. 19, 2011 (TW) 100129855

(51) Int. Cl. G06K 9/00

(52) U.S. Cl. 382/170

(57) ABSTRACT

A moving object detection method using image contrast enhancement includes receiving a source image, in which each pixel has a pixel illumination value; processing the source image using an image contrast enhancement procedure; executing a change detection procedure to compare a background model and the source image being processed using the image contrast enhancement procedure, and outputting a detection result accordingly; and executing a background and foreground separation procedure to output a moving object according to the detection result. The image contrast enhancement procedure may include generating a histogram of pixel illumination values; calculating a dynamic distribution range and a cumulative distribution function (CDF) of the source image based on the histogram; executing a mapping table generation procedure to generate a mapping table based on the dynamic distribution range and the CDF; and modifying pixel illumination values based on the mapping table to enhance image contrast of the source image.

### CROSS-REFERENCE TO RELATED APPLICATIONS

This non-provisional application claims priority under 35 U.S.C. §119(a) on Patent Application No(s). 100129855 filed in Taiwan, R.O.C. on Aug. 19, 2011, the entire contents of which are hereby incorporated by reference.

### BACKGROUND

1. Technical Field

The disclosure relates to a moving object detection method with image contrast enhancing steps, and more particularly to an image contrast enhancement method using a histogram and a moving object detection method employing the image contrast enhancement.

2. Related Art

An image processing method may be used in various fields. For example, the image processing method may be applied in video surveillance or security monitoring service. Taking video surveillance as an example, in the past decade, the closed-circuit video surveillance system has been used for safety related purposes. However, a conventional surveillance system is only capable of recording images, but is incapable of analyzing an object or event. With the development of digital video and digital image processing, an intelligent surveillance system based on computer vision already becomes increasingly popular in the field of surveillance. For example, the intelligent surveillance system may be deployed at airports, metro stations, banks or hotels to recognize terrorists or suspects. The intelligent surveillance system is capable of automatically analyzing images captured by an image capture device and identifying and tracking moving objects, for example, people, vehicles, animals or objects.

However, to analyze an image, it is necessary to identify foreground objects and background objects of the image. Accordingly, change detection is performed on the image to identify still background and moving foreground object in the image. However, when the image has high noises, poor image contrast, partial or global sudden illumination changes or shadows or is shot while weather condition changes, analysis errors occur easily, resulting in identification failure of the intelligent surveillance system.

Conventionally, to solve these problems, comparison and complicated compensation that consumes a large amount of computational resources are required for possible situations one by one. For example, it should be determined whether a rapid illumination change occurs on the current image when the prior image is compared with. If the change occurs, the image requires compensation to acquire an image having proper exposure. However, the conventional approach may cause detection failures, inappropriate auto exposure (AE) manner for compensation and inappropriate settings of compensation reference points or threshold values, such that subsequent analysis errors still occur to the compensated image.

### SUMMARY

In order to solve the above problem, the disclosure is directed to a moving object detection method using image contrast enhancement. The image contrast enhancement method comprises: receiving a source image comprising a number of pixels each of which has a pixel illumination value; generating a histogram of the pixel illumination values; generating a dynamic distribution range and a cumulative distribution function (CDF) of the source image based on the histogram; executing a mapping table generation procedure to generate a mapping table based on the dynamic distribution range and the CDF; and modifying pixel illumination values based on the mapping table to enhance contrast of the source image.

The dynamic distribution minimum value in the dynamic distribution range may equal the minimum pixel illumination value and the dynamic distribution maximum value in the dynamic distribution range may equal the maximum pixel illumination value.

In an embodiment, the mapping table generation procedure may expand the dynamic distribution range by a linear histogram equalization to generate a mapping table. The mapping table may comprise a number of input values and a number of output values corresponding to the input values in a one-to-one manner, and the mapping table generation procedure may expand the dynamic distribution range by using the following equation:

$${Y}_{output} ( {Y}_{input} ) = \frac{CDF ( {Y}_{input} ) - CDF ( {h}_{min} )}{CDF ( {h}_{max} ) - CDF ( {h}_{min} )} \times 255$$

wherein Yᵢₙₚᵤₜ is an input value; Yₒᵤₜₚᵤₜ is an output value; is a dynamic distribution minimum value, and hₘₐₓ is a dynamic distribution maximum value.

In another embodiment, the mapping table generation procedure may expand the dynamic distribution range in a nonlinear manner to generate a mapping table.

Before the step of calculating a dynamic distribution range and a CDF of the source image based on the histogram, the image contrast enhancement method may further comprise: executing a denoise procedure on the histogram.

In the moving object detection method using image contrast enhancement provided in the disclosure, the image contrast enhancement method is implemented as an image contrast enhancement procedure executed by a computer. The moving object detection method using image contrast enhancement comprises: receiving a source image; processing the source image using the image contrast enhancement procedure; executing a change detection procedure by the computer to compare a background model to the source image being processed using the image contrast enhancement procedure and, then, outputting a detection result accordingly; and executing a background and foreground separation procedure to output at least one moving object according to the detection result.

The step of comparing a background model and the source image being processed using the image contrast enhancement procedure and outputting a detection result accordingly may comprise: generating a difference image based on the background model and the source image being processed using the image contrast enhancement procedure; and comparing a change threshold value to the difference image and outputting a detection result accordingly.

In conclusion, with respect to the moving object detection method using image contrast enhancement, the conventional complicated comparison procedure and compensation procedure of the prior art are replaced by expanding the dynamic distribution range of the histogram and generating the mapping table for compensating for the pixel illumination value. Therefore, compared with the conventional approach, the disclosure further has the efficacy of saving the computational resources, improving the processing efficiency, and practically facilitating change detection and background and foreground separation.

### BRIEF DESCRIPTION OF THE DRAWINGS

The present disclosure will become more fully understood from the detailed description given herein below for illustration only, and thus are not limitative of the present disclosure, and wherein:

FIG. 1 is a schematic block diagram of a moving object detection method using image contrast enhancement according to an embodiment;

FIG. 2 is a flow chart of a moving object detection method using image contrast enhancement according to an embodiment;

FIG. 3 is a flow chart of an image contrast enhancement procedure according to an embodiment;

FIG. 4A is a schematic diagram of a source image according to an embodiment;

FIG. 4B is a histogram of a source image according to an embodiment;

FIG. 5A is a schematic diagram of a source image being processed using the image contrast enhancement procedure according to an embodiment;

FIG. 5B is a histogram of a source image being processed using the image contrast enhancement procedure according to an embodiment;

FIG. 6A is a schematic diagram of a source image according to an embodiment; and

FIG. 6B is a source image being processed using a moving object detection method through image contrast enhancement according to an embodiment.

### DETAILED DESCRIPTION

The detailed features and advantages of the disclosure are described below in great detail through the following embodiments, the content of the detailed description is sufficient for those skilled in the art to understand the technical content of the disclosure and to implement the disclosure there accordingly. Based upon the content of the specification, the claims, and the drawings, those skilled in the art can easily understand the relevant objectives and advantages of the disclosure.

The disclosure relates to a moving object detection method using image contrast enhancement for detecting at least one moving object in a source image in various situations such as a condition of fierce illumination changes.

The image contrast enhancement method and the moving object detection method using image contrast enhancement may be implemented, for example, by a surveillance system. The surveillance system captures at least one source image with an image detector and uses a processor to execute the image contrast enhancement method or the moving object detection method using image contrast enhancement. However, the image contrast enhancement method or the moving object detection method using image contrast enhancement may also be implemented in hardware with a processor such as a server, a personal computer or a surveillance device. Also, the image contrast enhancement method and the moving object detection method using image contrast enhancement may be separately implemented.

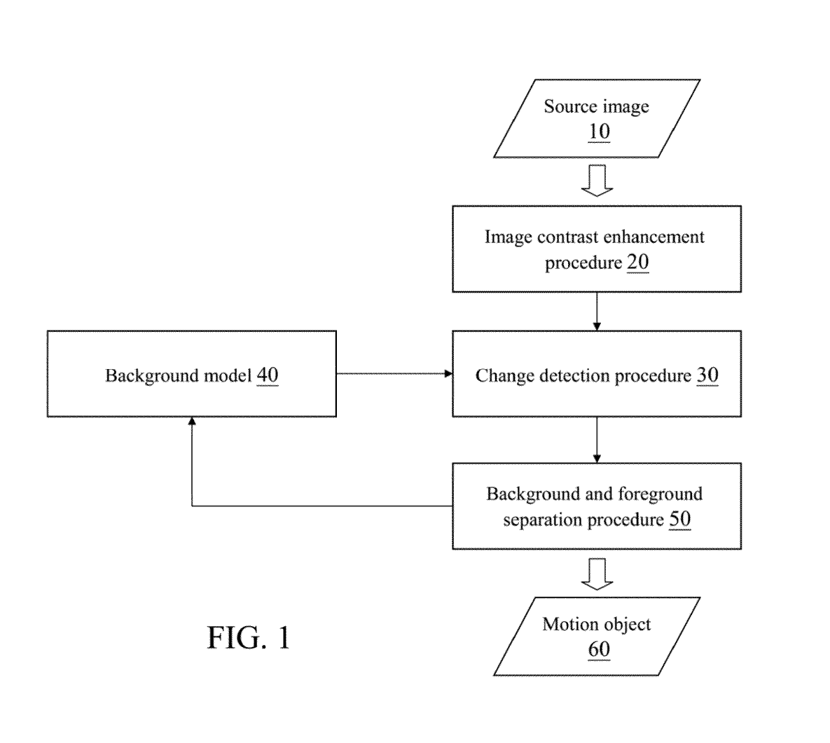

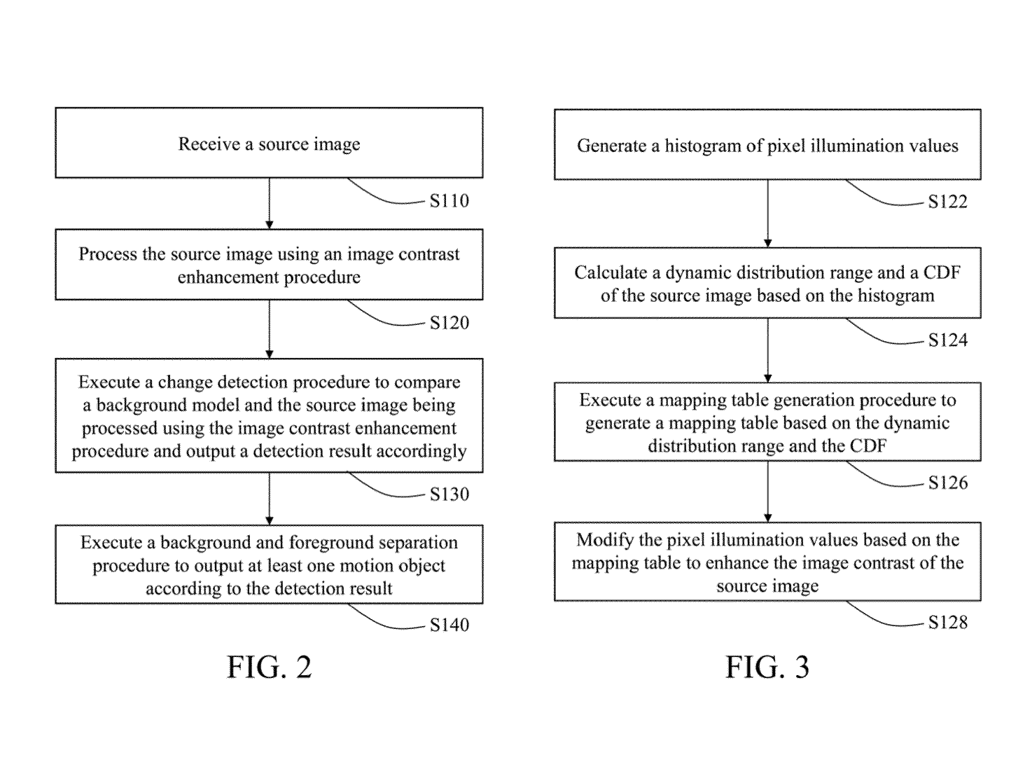

Refer to FIG. 1 and FIG. 2 at the same time. FIG. 1 is a schematic block diagram of a moving object detection method using image contrast enhancement according to an embodiment. FIG. 2 is a flow chart of a moving object detection method using image contrast enhancement according to an embodiment.

First, a processor receives a source image 10 (Step S110). The source image 10 comprises a number of pixels and each pixel has a pixel illumination value. The processor processes the source image 10 using an image contrast enhancement procedure 20 (Step S120). In the moving object detection method using image contrast enhancement provided in the disclosure, the image contrast enhancement method is implemented as the image contrast enhancement procedure 20. In the moving object detection method using image contrast enhancement, it is not required to additionally determine whether a situation of a partial or global sudden illumination change occurs when the image detector is capturing the source image 10, and also not required to analyze the quality of the image contrast of the source image 10 or whether the source image 10 has undesirable AE, thereby greatly reducing the required computational and time cost. In other words, the conventional complicated and possibly inaccurate detection and compensation method are replaced by the approach of processing all source images 10 using the image contrast enhancement procedure 20.

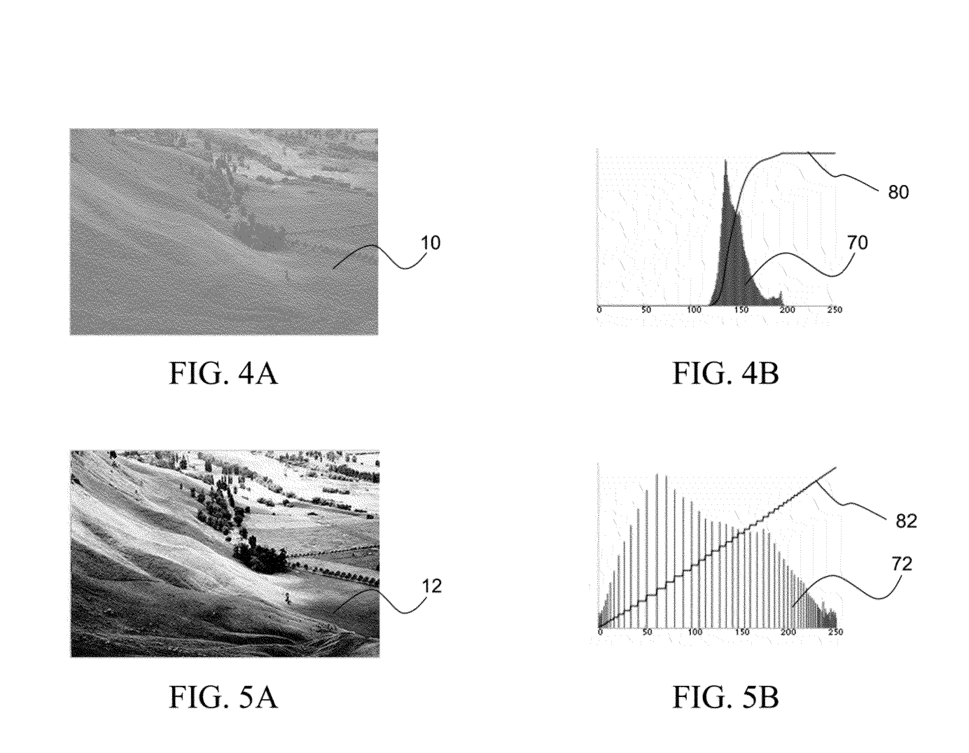

Next, refer to FIG. 3, FIG. 4A and FIG. 4B. FIG. 3 is a flow chart of an image contrast enhancement procedure according to an embodiment. FIG. 4A is a schematic diagram of a source image according to an embodiment. FIG. 4B is a histogram of a source image according to an embodiment.

In the image contrast enhancement procedure 20, after the image detector or a register receives the source image 10, a histogram 70 of a number of pixel illumination values of the source image 10 is generated (Step S122). The histogram 70 collects the number of pixels having the same pixel illumination value. Therefore, the histogram 70 may represent a distribution state of pixel illumination values in the source image 10. Taking FIG. 4A and FIG. 4B as examples, the pixel illumination values of the pixels of the source image 10 gather at a range between 120 and 200. Therefore, the image contrast is undesirable that a number of objects in the source image 10 are not easily recognizable and also detailed features in the image are not easily recognizable (for example, the slope surface at the lower left corner of the source image 10).

Next, a dynamic distribution range and a CDF 80 of the source image 10 are obtained based on the histogram 70 (Step S124). The CDF 80 represents an accumulative curve of the number of the pixels from low pixel illumination value to high pixel illumination value. The dynamic distribution minimum value of the dynamic distribution range may equal the minimum pixel illumination value and the dynamic distribution maximum value of the dynamic distribution range may equal the maximum pixel illumination value. For example, from the histogram 70, it may be seen that the minimum pixel illumination value is 115 and the maximum pixel illumination value is 210 so the dynamic distribution range may be set from 115 to 210.

However, in practice, the dynamic distribution range may also be adjusted according to the state of the source image 10. For example, the number of pixels falling in the smallest 20% and the greatest 20% of the original dynamic distribution range may be first calculated. When the number of pixels falling in the smallest or greatest 20% of the original dynamic distribution range is smaller than a ratio (for example, 10% of all pixels), it represents that the pixel illumination values of the pixels actually gather at the middle portion (for example, 60%) of the original dynamic distribution range. Therefore, the dynamic distribution range may be narrowed and the computation in the following steps may be performed with the narrowed dynamic distribution range. For example, when the original dynamic distribution range is between 50 and 250 and the pixel illumination values of the pixels gather at the middle portion (for example, 50%) of the original dynamic distribution range, the dynamic distribution range may be narrowed to 100 to 200.

In addition, the coefficient of variation or the standard deviation of the pixel illumination values may also be calculated first. When the coefficient of variation or the standard deviation is smaller than a threshold value, it represents that the pixel illumination values are gathered and the dynamic distribution range may be properly narrowed.

In another embodiment, before Step 124, the image contrast enhancement procedure 20 may further comprises a step of performing a denoise procedure on the histogram 70. If any pixel number corresponding to a pixel illumination value is lower than a threshold value, such pixel number is set to zero. Therefore, it may also prevent the small amount of excessively bright or dark pixels from affecting the execution result of the image contrast enhancement procedure 20.

After the dynamic distribution range and the CDF 80 are acquired, a mapping table generation procedure may be executed to generate a mapping table based on the dynamic distribution range and the CDF 80 (Step S126). Next, the pixel illumination values may be modified based on the mapping table to enhance the image contrast of the source image 10 (Step S128). The mapping table comprises a number of input values and a number of output values corresponding to the input values in a one-to-one manner. The input values are pixel illumination values before modification. The output values are pixel illumination value after modification. Therefore, in the image contrast enhancement procedure 20, the pixel illumination value of each pixel of the source image 10 may be modified according to the mapping table.

In order to turn the image contrast sharp, the image contrast enhancement procedure 20 may expand a dynamic distribution range gathered at a narrow portion of an illumination value range into the whole illumination value range. For example, the illumination value range is from 0 to 255. In other words, the image illumination values gathered at the dynamic distribution range are distributed into the whole illumination value range. Therefore, the source image 10 being processed using the image contrast enhancement procedure 20 has pixels with high, middle and low illumination values. However, the expanded distribution range is limited to 0 to 255. The image contrast enhancement procedure 20 may set the minimum output value in the mapping table smaller than or equal the dynamic distribution minimum value and set the maximum input value in the mapping table greater than or equal the dynamic distribution maximum value.

Specifically, the mapping table generation procedure may expand the dynamic distribution range in a linear or nonlinear manner to generate a mapping table. According to an embodiment, the mapping table generation procedure 20 may expand the dynamic distribution range by using the following equation:

$${Y}_{output} ( {Y}_{input} ) = \frac{CDF ( {Y}_{input} ) - CDF ( {h}_{min} )}{CDF ( {h}_{max} ) - CDF ( {h}_{min} )} \times 255$$

wherein Yᵢₙₚᵤₜ is an input value, Yₒᵤₜₚᵤₜ is an output value, hₘᵢₙ is a dynamic distribution minimum value, and hₘₐₓ is a dynamic distribution maximum value. Also, when CDF (Yᵢₙₚᵤₜ) is 0, Yₒᵤₜₚᵤₜ is directly set to 0. An objective of the linear histogram equalization equation is to equalize the histogram 70 into a shape of a uniform distribution histogram. In addition to the equation, the image contrast enhancement procedure 20 may adopt a nonlinear manner, for example, equalize the histogram 70 into a Gaussian distribution histogram or a histogram having other distribution characteristics.

Refer to FIG. 5A and FIG. 5B. FIG. 5A is a schematic diagram of a source image being processed using the image contrast enhancement procedure according to an embodiment. FIG. 5B is a histogram of a source image being processed using the image contrast enhancement procedure according to an embodiment. As shown in FIG. 5A and FIG. 5B, the source image 12 being processed using the image contrast enhancement procedure has sharp illumination contrast. Therefore, the objects and details in the image are all distinct and clear. It may be seen from the histogram 72 of the source image 12 being processed using the image contrast enhancement procedure 20, the modified pixel illumination values are more uniformly distributed in the illumination value range between 0 and 255. Accordingly, the rising rate of every part of the whole curve in the CDF 82 of the source image 12 being processed using the image contrast enhancement procedure 20 is nearly the same. However, the rising rate of some parts of the curve in the CDF 80 of the original source image 12 are steep.

After the source image 12 being processed using the image contrast enhancement procedure 20 is acquired, a change detection procedure 30 is executed on the source image 12 to compare a background model 40 to the source image 12 being processed using the image contrast enhancement procedure 20 and output a detection result accordingly (Step S130). Next, a background and foreground separation procedure 50 is executed on the detection result to output at least one moving object 60 according to the detection result (Step S140).

The background model 40 may be already established in advance and or established in real time according to a number of source images 10. The image points of the background model 40 may be described using a single Gaussian model or mixed Gaussian model. Generally speaking, the image point different from the background model 40 in pixel color value or pixel illumination value has a small Gaussian model value, while the image point similar to the background model 40 in pixel color value or pixel illumination value has a large Gaussian model value.

In this and some embodiments, Step S130 comprises the following steps: generating a difference image based on the background model 40 and the source image 12 being processed using the image contrast enhancement procedure 20; and comparing a change threshold value to the difference image and outputting a detection result accordingly. In other words, in the change detection procedure 30, the source image 12 being processed using the image contrast enhancement procedure 20 is subtracted by the background model 40 to acquire a difference image and then whether a change occurs in a picture of the image is determined according to the difference value. In addition, the change detection procedure 30 may also perform change detection on a predetermined random picture area or perform change detection in other manners, which are not limited here.

To output a moving object 60, the background and foreground separation procedure 50 may analyze adjacent areas of each pixel and determine whether the foreground object moves by using the detection result output in Step S130. Also, the background and foreground separation procedure 50 may feed the retrieved data such as the foreground object and the moving object 60 back to the background model 40 to correct and improve the background model 40 in real time.

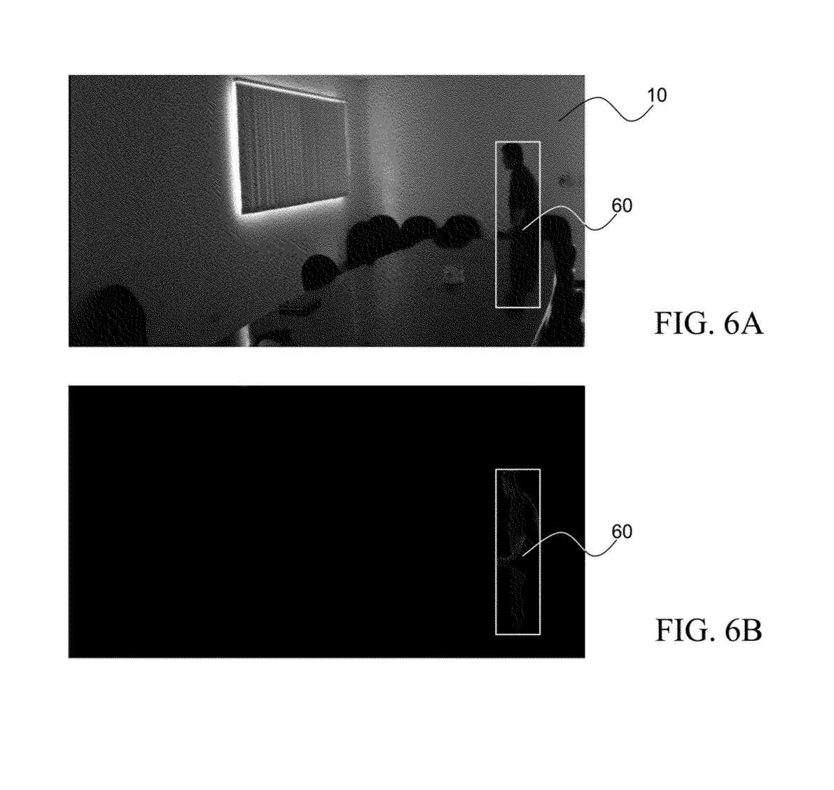

Refer to FIG. 6A and FIG. 6B. FIG. 6A is a schematic diagram of a source image according to an embodiment. FIG. 6B is a schematic diagram of a source image being processed using a moving object detection method through image contrast enhancement. In FIG. 6A, the illumination of the whole source image 10 is low and the illumination and colorfulness of the moving object are close to some objects of the background. However, after the processing of the moving object detection method using image contrast enhancement, the foreground and background separation procedure 50 is capable of identifying and outputting the moving object 60, as shown in FIG. 6B. In conclusion, the image contrast enhancement procedure does not need to analyze situations such as whether the source image has undesirable image contrast or a partial or global sudden illumination change, and instead directly perform processing of histogram equalization. The computation for expanding the dynamic distribution range of the histogram to generate a mapping table for compensating pixel illumination values is very simple and fast, and therefore, the conventional complicated comparison and compensate procedures may be omitted. Moreover, as the source image being processed using the image contrast enhancement procedure already has desirable image contrast, both the subsequent change detection procedure and the background and foreground separation procedure are capable of accurate detection and determination, so correct moving objects may be output.

What is claimed is:

1. A moving object detection method using image contrast enhancement, comprising:
receiving a source image comprising pixels, each pixel having a pixel illumination value;
processing the source image using an image contrast enhancement procedure, the image contrast enhancement procedure comprising:
generating a histogram of the pixel illumination values;
generating a dynamic distribution range and a cumulative distribution function (CDF) of the source image based on the histogram;
executing a mapping table generation procedure to generate a mapping table based on the dynamic distribution range and the CDF; and
modifying the pixel illumination values based on the mapping table to enhance image contrast of the source image;
executing a change detection procedure to compare a background model to the source image being processed using the image contrast enhancement procedure, and outputting a detection result; and
executing a background and foreground separation procedure to output at least one moving object according to the detection result.

2. The moving object detection method using image contrast enhancement according to claim 1, wherein a dynamic distribution minimum value of the dynamic distribution range equals a minimum pixel illumination value and a dynamic distribution maximum value of the dynamic distribution range equals a maximum pixel illumination value.

3. The moving object detection method using image contrast enhancement according to claim 2, wherein the mapping table generation procedure expands the dynamic distribution range in a linear histogram equalization manner to generate the mapping table.

4. The moving object detection method using image contrast enhancement according to claim 3, wherein the mapping table comprises a number of input values and a number of output values corresponding to the input values in a one-to-one manner, the mapping table generation procedure expands the dynamic distribution range through the following equation:
$${Y}_{output} ( {Y}_{input} ) = \frac{CDF ( {Y}_{input} ) - CDF ( {h}_{min} )}{CDF ( {h}_{max} ) - CDF ( {h}_{min} )} \times 255 ;$$
wherein Yᵢₙₚᵤₜ is one of the input values, Yₒᵤₜₚᵤₜ is one of the output values, hₘᵢₙ is the dynamic distribution minimum value and hₘₐₓ is the dynamic distribution maximum value.

5. The moving object detection method using image contrast enhancement according to claim 2, wherein the mapping table generation procedure expands the dynamic distribution range in a nonlinear manner to generate the mapping table.

6. The moving object detection method using image contrast enhancement according to claim 1, wherein before the step of calculating the dynamic distribution range and the CDF of the source image based on the histogram, the image contrast enhancement procedure further comprises:
executing a denoise procedure on the histogram.

7. The moving object detection method using image contrast enhancement according to claim 1, wherein the step of comparing the background model and the source image being processed using the image contrast enhancement procedure and outputting the detection result accordingly comprises:
generating a difference image based on the background model and the source image being processed using the image contrast enhancement procedure; and
comparing a change threshold value to the difference image and outputting the detection result accordingly.
